(19) United States
(12) Patent Application Publication
(10) Pub. No.: US 2015/0046253 A1
(43) Pub. Date: Feb. 12, 2015

(54) Methods Circuits Apparatuses Systems and Associated Computer Executable Code For Providing Dynamic Customer Engagement

(71) Applicant: Kampyle Ltd., Ramat Gan (IL)

(72) Inventor: Ariel Finkelstein, Zichron Yaakov (IL)

(73) Assignee: Kampyle Ltd., Ramat Gan (IL)

(21) Appl. No.: 13/959,772

(22) Filed: Aug. 6, 2013

(51) Int. Cl. G06Q 30/02

(52) U.S. Cl. CPC G06Q 30/0251; G06Q 30/0242; G06Q 30/0243
USPC 705/14.42; 705/14.49; 705/14.41

(57) ABSTRACT

Disclosed are methods, circuits, apparatuses, systems and associated computer executable code for providing dynamic customer engagement. According to some embodiments, an engagement code generator translates one or more engagement rules, including targeting conditions and corresponding triggered actions, into dynamic engagement code, which may be self-executing and may be locally cached, including a rule engine corresponding to the translated one or more engagement rules. Once instanced or running on a customer browser, the code and rule engine provide for dynamic customer interaction.

### FIELD OF THE INVENTION

The present invention relates generally to the field of data processing and customer support systems. More specifically, the present invention relates to methods, circuits, apparatuses, systems and associated computer executable code for providing dynamic customer engagement, optionally online.

### BACKGROUND

Customer engagement and satisfaction is recognized by many as the cornerstone of a successful business or enterprise. As the world has transitioned into the “digital age” with the internet and other forms of digital communication becoming pervasive in people's daily lives, businesses and enterprises have likewise evolved and almost without exception established a presence on the internet to provided customer and potential new customers easy access to information, customer service and points of purchase for an apparently endless variety of goods and services. Online and otherwise digitally facilitated sales of goods and services steadily increase on a daily basis, and thus the importance of most enterprise's online presences is likewise increasing.

As powerful a channel for marketing and sales an online presence may be, it also presents challenges for enterprises they represent. Providing customers, potential customers, site visitors, web-site users, etc. a user engagement and/or experience customized event partially for them is a complicated endeavor for enterprises selling/servicing online to a huge number of demographically and socioeconomically diverse customers. Therefore, there is a need for methods, circuits, apparatuses, systems and associated computer executable code for providing dynamic customer engagement, optionally online as part of e-commerce or customer service systems and solutions.

### SUMMARY OF THE INVENTION

The present invention includes methods, circuits, apparatuses, systems and associated computer executable code for providing automated dynamic engagement with either a potential or a current customer or client (hereinafter “Customer”) of an enterprise. According to some embodiments, there may be provided one or more automated consumer access portals or customer communication channels (hereinafter “Customer Portal” or “Enterprise Touch Point”) through which a Customer may visit or interact with an enterprise and may be dynamically engaged (a Customer may also be referred to as a visitor). Dynamic customer engagement may include selection between one or more engagement methods, modes, techniques or modalities to initiate with the Customer during their interaction with the Customer Portal or Touch Point. Dynamic customer engagement may also include selection between one or more offers to present to the Customer during their interaction with the Customer Portal. Dynamic customer engagement may be based on a rule-set which takes into account: (1) one or more customer parameters or attributes, (2) past or current customer activities (hereinafter “Customer Activities”), and/or (3) one or more parameters associated with a condition (e.g. time, Customer Location, Weather, etc.) during the Customer's interaction with the Customer Portal/touch-point. Information relating to one or more Customer Attributes and/or Customer Activities may be extracted from one or more, integrated or unassociated, data processing systems of the enterprise. Information relating to one or more Customer Attributes and/or Customer Activities may further be extracted from one or more, integrated or unassociated, social networks, third party data sources, or other publically accessible data repositories (e.g. Online Directories, Social Networks, Credit Services, etc.). According to embodiments of the present invention, a Customer approaching and interacting with a Customer Portal or Touch-Point of an enterprise, who can also be referred to as a visitor, may be dynamically engaged, substantially in real-time, and in a manner either manually or automatically customized to the Customer within the context of goals or interests defined by the enterprise.

According to further embodiments, there may be provided a system for dynamic customer engagement, which system may include a dynamic engagement code generator adapted to translate a set of engagement rules into (optionally: self-executable) dynamic engagement code containing a rule engine configured substantially in accordance with the set of engagement rules. Each rule may include at least one targeting condition along with a corresponding triggered engagement action. The system may also include a computer server (e.g. Web Server, Application Server, etc.) from which the dynamic engagement code may be transferred onto a customer related computing platform for execution.

The dynamic engagement code may be functionally associated with a campaign or company specific configuration file, such that the functionally associated configuration file may either override a native behavior of the rule engine or may provide an operational parameter (e.g. file name, URL, etc.) for a triggered action of said rule engine. The dynamic engagement code may be lazy loading code. The dynamic engagement code may launch at least one locally cached process on the customer related computing platform. The dynamic engagement code may include a network communication component adapted to, once executed on the customer related computing platform, communicate with one or more communication modules on the dynamic customer engagement system.

According to further embodiment, the system may include an engagement code communication module adapted to facilitate communication between engagement code running on a customer related computing platform and one or more resources of said dynamic customer engagement system. The system may also include one or more data collectors adapted to retrieve customer related information or enterprise state related information from one or more data systems, wherein the one or more data systems may either be enterprise data systems, publically accessible data systems or third party data systems. The data collectors may be adapted to generate and store a customer data structure reflective of the retrieved information. The data collectors may be adapted to provided collected information substantially directly to the self-executing code running on a customer related computing platform through an engagement code communication module. One or more data collectors adapted to retrieve enterprise state related information from one or more data systems may be further adapted to provide the retrieved information to an automated engagement rule tuning module. The one or more data collectors may include an interface selected from the group of interfaces consisting of: (1) a Social Network Interface, (2) a CRM System Interface, (3) a Customer Survey/Feedback System Interface, (4) a Accounting System Interface, (5) a Fulfillment/Delivery System Interface, (6) a Inventory/Supply Management System interface, (7) a Data Mining and Business Intelligence System Interface, and (8) a Third Party Data System Interface.

According to embodiments, the system may include one or more client engagement interfaces adapted to facilitate an actual customer engagement, according to a defined engagement method, responsive to a triggering action from said dynamic engagement code running on a customer related computing platform. A facilitated engagement may be according to an engagement method selected from the group of: (1) presenting a customer with a reward or special offer, (2) providing a customer with a discount, coupon or rebate, (3) triggering a chat session between the customer and a representative, (4) triggering an automated response session, and (5) triggering live call between the customer and a representative.

The system may also include an engagement method effectiveness assessment module adapted to assess an effectiveness level of a given engagement method under specific targeting conditions by monitoring customer interactions with one or more actual customer engagements according to the given engagement method and triggered based on the specific targeting condition. The effectiveness assessment module may further be adapted to provide assessment information to one or more of: (1) an automated engagement rule tuning module, and (2) a real-time reporting system. The effectiveness assessment module may further be adapted to assess relative effectiveness levels of two or more engagement methods whose actual engagements are being triggered from the same customer portal using substantially identical targeting conditions.

The effectiveness assessment module may convey to an automated engagement rule tuning module information indicative of the relative effectiveness of the two or more engagement methods and the automated engagement rule tuning module may adjust engagement rules accordingly. For example, engagement rules may be adjusted in favor of relatively more prevalent triggering of actual engagements accordingly to engagement methods assessed of as being associated with relatively higher effectiveness levels.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a concept level diagram showing two separate customers or visitors interacting with a customer portals and manned customer service terminals of an enterprise whose data processing systems include a dynamic customer engagement system according to embodiments;

FIG. 2A is a functional block diagram of an exemplary dynamic customer engagement system according to embodiments;

FIG. 2B is a functional block diagram of a computing platform/device running exemplary dynamic engagement code according to embodiments where the code is browser executable code;

FIG. 2C is a functional block diagram of a computing platform/device running exemplary dynamic engagement code according to embodiments where the code is embedded within an application running on the platform/device;

FIG. 3A is a flow chart including exemplary steps of a dynamic customer engagement system according to embodiments;

FIG. 3B is a flow chart including exemplary deployment steps of a dynamic customer engagement system according to embodiments;

FIG. 3C is a flow chart including exemplary engagement steps of a dynamic customer engagement system according to embodiments; and

FIG. 4 is a symbolic representation of the logical elements and associated information flow present in an exemplary embodiment of a dynamic customer engagement system according to embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

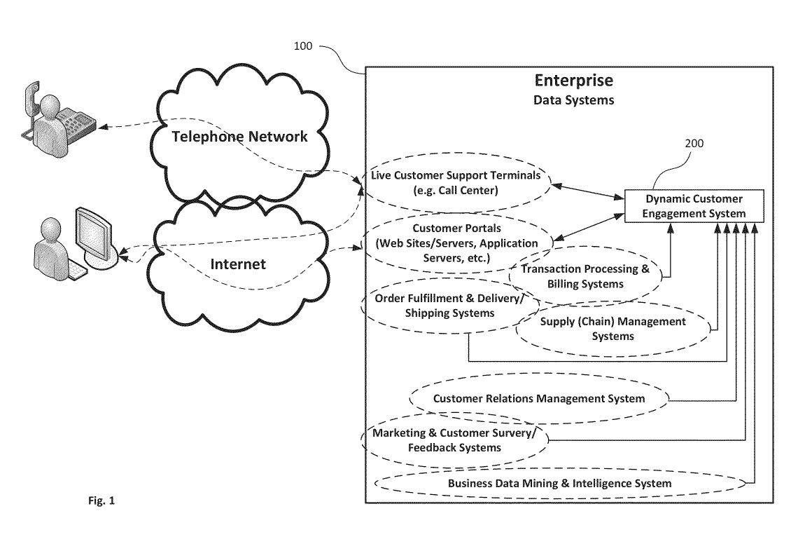

Turning now to FIG. 1, there is shown a concept level diagram showing two separate customers or visitors interacting with enterprise customer portals and manned customer service terminals, either of which may be referred to as enterprise touch points. The touch points are shown as being part of or otherwise connected to enterprise data systems 100 which include or are otherwise connected to a dynamic customer engagement system 200 according to embodiments. The customer engagement system 200 according to embodiments receives data from various data sources throughout the enterprise data processing system 100 and optionally from third party data sources such as publically available databases, social networks, other enterprises, and credit agencies. The customer engagement system 200 provides dynamic engagement code to the touch points and receives engagement related information from the touch points.

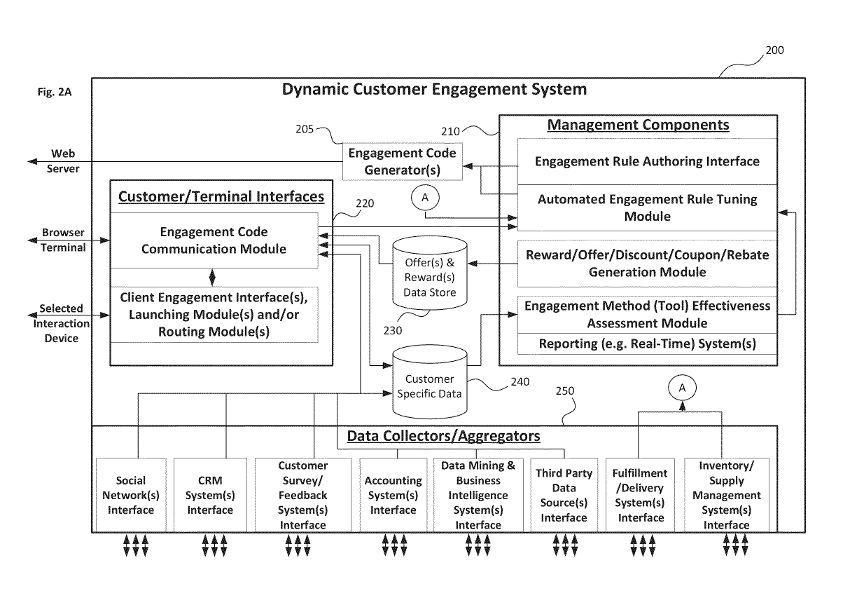

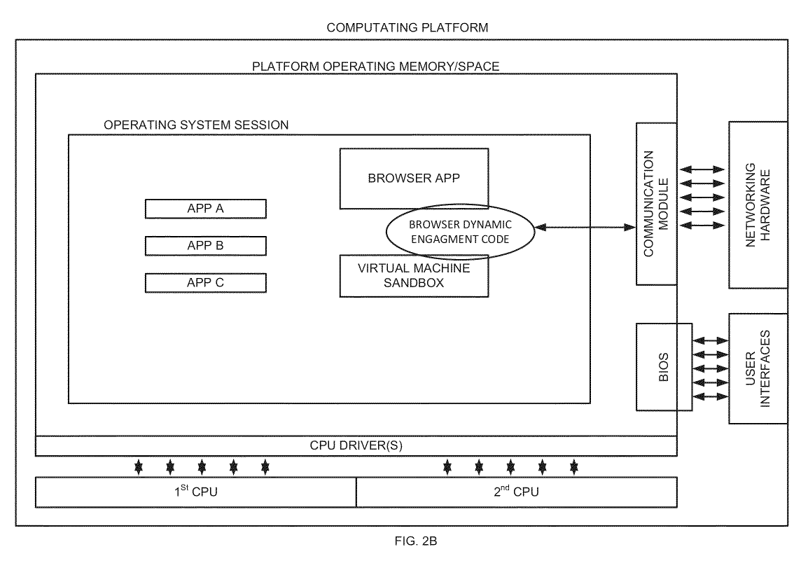

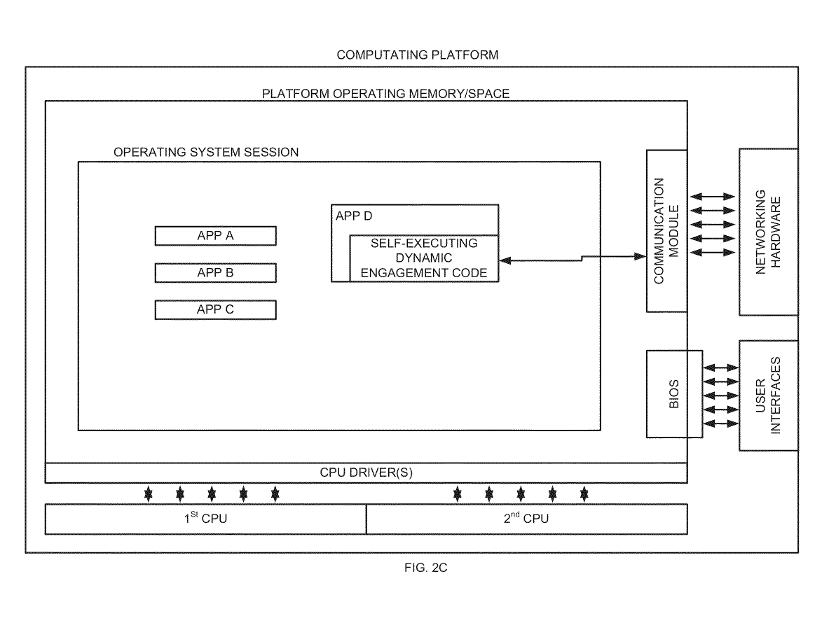

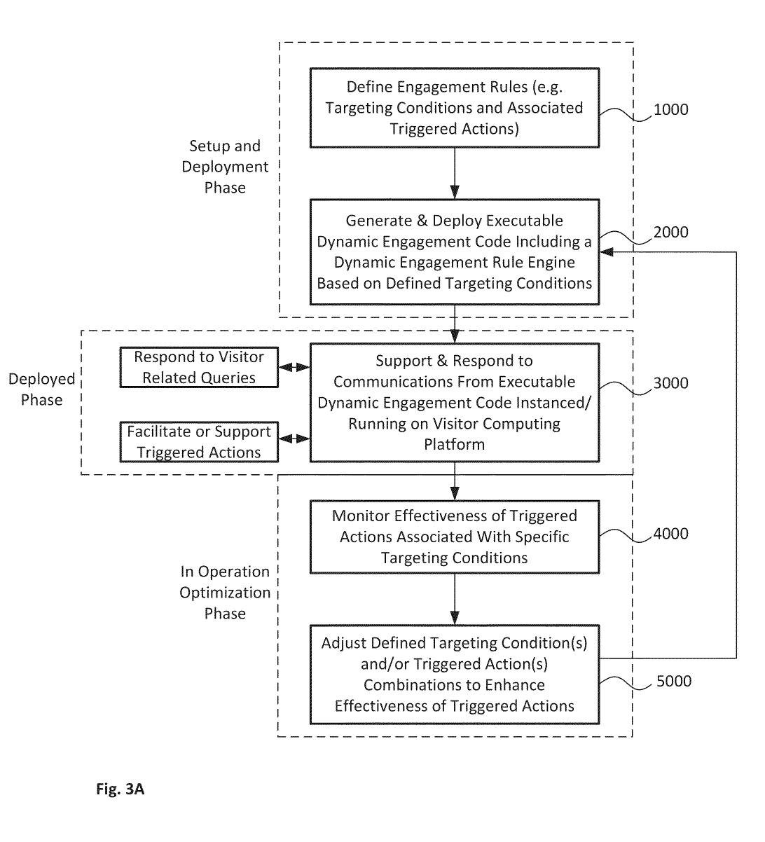

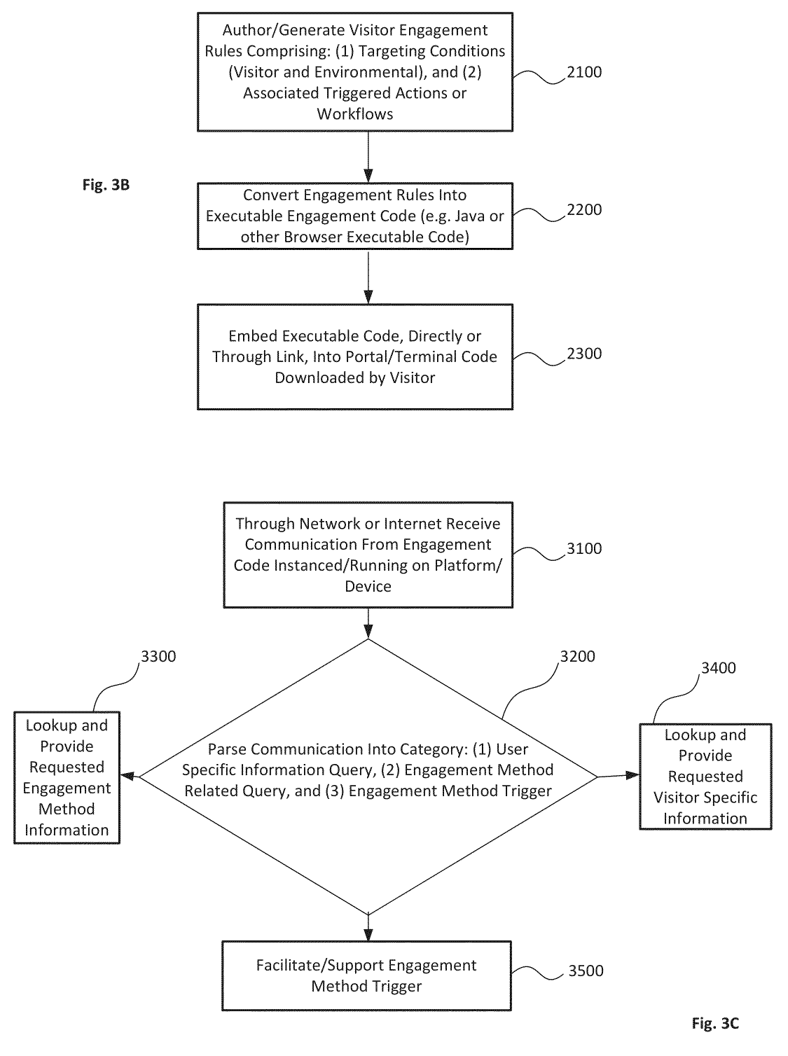

Turning now to FIG. 2A, there is shown a functional block diagram of an exemplary dynamic customer engagement system (“DCES”) 200 according to embodiments. The system's operation may be described in conjunction with the steps illustrated in the flowchart of FIG. 3A, which flowchart includes exemplary setup, deployment, operating and tuning steps of a dynamic customer engagement system 200 according to embodiments. The DCES 200 includes one or more dynamic engagement code generator(s) 205 adapted to generate dynamic engagement code (e.g. browser executable or self-executing) including: (1) a set of targeting parameters, and (2) one or more functions for triggering one or more engagement actions, wherein a given engagement action is triggered upon detection of a condition associated with targeting parameter corresponding to the given action. The dynamic engagement code generator 205 may be adapted to translate a set of engagement rules into dynamic engagement code containing a rule engine configured and operative substantially in accordance with the set of engagement rules. Each one or set of engagement rules may include at least one targeting condition along with a corresponding engagement action to be triggered upon detection of the at least one targeting condition.

The dynamic engagement code generator 205 may reside upon or be otherwise functionally associated with a computer server (e.g. Web Server, Application Server, etc.) from which the dynamic engagement code may be transferred onto a customer related computing platform for execution. The dynamic engagement code generator 205 may generate the code based on engagement rules defined by a user and/or based on engagement rules tuned by one or more feedback mechanisms of the system 200.

The system 200 may include management components 210 such as: (1) engagement rule authoring interfaces; (2) automated engagement rule tuning modules; (3) reward, offer, discount, coupon, rebate generation modules (it should be understood that the terms reward, offer, discount, coupon, rebate and the like may be used interchangeably and may collectively be referred to as an “offer”); (4) engagement method effectiveness assessment modules; and (5) reporting modules/systems. The engagement rule authoring interface may provide a user, such as a party at an enterprise implementing offers and/or customer support options for a touch-point (e.g. website, portal, customer service personnel/terminal, etc.) user/visitors, with either a structured language and/or (dynamic or static) menu based interface by which to define one or more engagement rules, wherein each engagement rule may include at least one targeting parameter or condition, at least one engagement action (commercial offer or communication option) to be triggered upon the condition occurring or being met, and optionally a link to one or more digital objects associated with an offer (FIG. 3A: step 1000).

A targeting condition may be associated with a characteristic of the visitor and/or upon a condition surrounding a time and/or location from which a visitor approaches a touch-point. The visitor characteristic may be known, for example based on account credentials provided during a visitor approach or login to a touch-point, or the visitor characteristic may be guessed/derived based on conditions surrounding and/or characteristics of an interaction between the visitor and the touch-point. Visitor characteristics may be extracted from various data sources, including enterprise data sources and third party data sources, via data collectors and/or aggregators 250. Visitor characteristics for specific visitors may be stored in a data store 240. Exemplary targeting conditions relating to a characteristic of a visitor may include age, gender, account status, current or past activities, visitor address or location (based on IP address or location information from a mobile device).

Exemplary targeting conditions relating to a condition surrounding a visit may include time of visit, date of visit, duration of visit, activity at touch-point during visit, frequency of visits, weather at location from which a visitor is approaching a touch-point. According to further embodiments, characteristics of activities during touch-point visits by a given unknown visitor whose identity has not been determined may be recorded in a data store, for example in data store 240. Upon identification of the given unknown visitor, some of all the recorded characteristics may be associated to the identified visitor for current or future engagement targeting.

Exemplary engagement actions which may be triggered responsive to one or more corresponding targeting conditions being met may include: (1) suggesting or launching one or more interaction mechanisms to the visitor, and/or (2) suggesting or providing one or more commercial offers to the visitor (FIG. 3A, step 3000).

Turning now to FIG. 3B, there is a flowchart including steps of an exemplary process by which dynamic engagement code may be authored and deployed. Initially one or more engagement rules are authored or generated (FIG. 3B: step 2100), wherein at least one of the rules defines one or more targeting conditions, which conditions may be detected using one or more targeting parameters or rules, along with one or more associated/corresponding engagement actions to be triggered when the one or more targeting conditions are met. The authored or otherwise generated engagement rules are then converted into executable engagement code (FIG. 3B: step 2200), which engagement code includes a rule engine and is then embedded into a downloadable code package (FIG. 3B: step 2300), for example into browser executable code to be executed by a web-browser (FIG. 2B) and/or into a software application (FIG. 2C). The dynamic engagement code, either self-executing or browser executable, may be lazy loading code, wherein that lazy loading is a method to defer initialization of an object until the point at which it is needed. This method may contribute to efficiency in the program's operation. This method may be used in loading of the different modules (engagement modules/tools) or data objects, so that it's possible to load modules or data objects that are specific to enterprises, customer segments and/or conditions. For example, an enterprise may want to have different branded coupons offered under different targeting conditions, and lazy loading provides for only the relevant coupons to be loaded as needed. Authored engagement rules or rule sets may be conveyed to the engagement code generator 205 for immediate or scheduled code generation and deployment (FIG. 3A: step 2000 and FIG. 3B: step: 2200/2300). Alternatively, the authored engagement rule(s) may be stored for subsequent generation and deployment.

Turning now to FIG. 3C, there is shown a flow chart indicating exemplary engagement steps of a dynamic customer engagement system according to embodiments. Upon execution of dynamic engagement code upon a computing platform (e.g. Personal Computer, Smart Phone, etc.) of touch-point visitor and/or a customer service person approached by a visitor (FIGS. 2B & 2C), the dynamic engagement code activates its respective rule engine, and optionally applies to the rule engine or to ancillary functional modules of the executable code configuration parameters from an associated configuration file. One or more modules of the dynamic engagement code checks for, or attempt to detect, one or more parameters associated with targeting conditions of the rule engine. For example, the modules may monitor a touch-point login or may receive feedback from the system 200 of a specific login. The module may detect a cookie or other unique identifier present on the computing platform/device. The module may monitor activity during and/or determine characteristics associated with a given visit.

Dynamic engagement code running on a computing platform/device may communicate with the system 200 through networking hardware of the computing platform (FIGS. 2B and 2C) and through the system's 200 engagement code communication module (FIG. 2A). Over this communication link the code may receive (e.g. stored) information relating to a specific visitor (FIG. 3C, steps 3100, 3200 and 3400). Additionally, the dynamic engagement code may receive from the system data and/or files relating to specific engagement actions or methods to be triggered (FIG. 3C, step 3300). Engagement actions or methods to be triggered may be facilitated or otherwise supported (FIG. 3C, steps 3500), for example through a client engagement interface(s), launching module(s) and/or routing module(s) (FIG. 2A). Detection of one or more parameters associated with a given targeting condition of the rule engine may be detected by engagement code alone, or using data received from the system 200 (step 3400). One or more engagement actions corresponding to the given condition may be triggered by the engagement code alone, or using data and/or facilities by provided by the system 200 (steps 3300 & 3500).

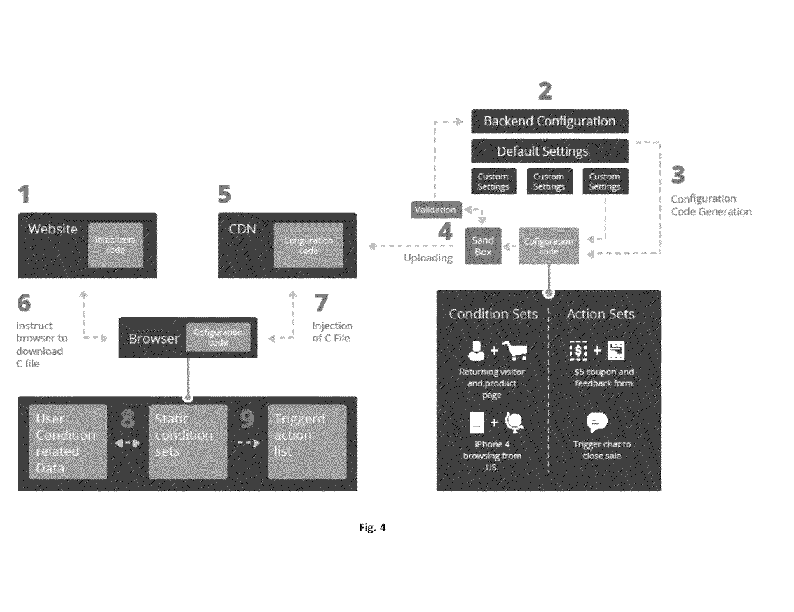

Turning now to FIG. 4, there is shown a symbolic representation of logical elements and associated information flow present in an exemplary embodiment of a dynamic customer engagement system. The system embodiment shown in FIG. 4 relates to a system and methods which allow companies (the term will hereon apply to entire companies or specific business units within a company) to manage customer specific (end-user specific) interactions. The system of FIG. 4 uses a configuration file comprised of a rule engine and a static list containing a preconfigured mapping between targeting conditions and engagement actions (‘rule’ list). Rules on the list are comprised of sets of one or more targeting conditions paired with sets of one or more engagement actions. The configuration undergoes a sandbox process for syntax validation and company approval, and then is uploaded to a server (CDN or other).

Whenever a customer interacts with the company website or application and the most recent version of the configuration is not present on the device, it is downloaded to the customer device (in the form of a Java script). After the configuration file is locally cached on the customer's device, a matching process on the customer side occurs between dynamic customer data (behavior or other characteristics) and static targeting conditions (from the list in the configuration). The matching method is defined in the rule engine logic. Every match triggers the corresponding set of actions using a “lazy loading” technique of dynamic modules from the provider's (e.g. Kampyle) server. The system's operational flow includes:
At the time of deployment a short snippet of code is implemented on the company's website, to be used as a process initializer (init.js).
2. A backend configuration process in which engagement rules are defined and stored in a static state is performed. Rules are comprised of one or more targeting conditions paired with one or more engagement actions. Rules can be set as default and impact the entire company database or can be customized to only affect specific companies. Ideally, rules are defined according to a company's goals and business logic.
3. A configuration file containing both predefined rule engine logic and the static list of rules is generated.
4. The configuration file undergoes a sandbox process for validation and company approval. If it is not successful the file is returned to stage 2 for reconfiguration.
5. Following a successful sandbox process the configuration is uploaded onto a server (in our case an external CDN server).
6-7. At the point interaction between a customer's device (e.g. browser/mobile) with the company's touch point (e.g. website/app), the initializer checks if the device contains the most recent configuration file, if not, the initializer orders the customer's device to request the server to inject it with the updated configuration. The configuration is then downloaded onto the customer's device.
8. In a locally cached process, the customer's device facilitates a matching method between the static conditions pre-defined in the configuration and the customer's dynamic targeting related data (behavioral, technical or any other type available on the customer's device or the provider's servers). The matching method is defined in the rule engine using predefined comparators to attach a Boolean value to each condition in the list of rules. Also defined in the rule engine is the process of matching itself.
9. If a customer fully fits one or more sets of targeting conditions the corresponding sets of actions are triggered and only then the relevant dynamic modules are loaded from the provider's server in a “lazy loading” technique. Most of this process takes place on the customer's device and does not encumber the client's servers or the CDN/Kampyle servers unless it is required (e.g. the data is not available on the customer's device).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A system for providing dynamic customer engagement, said system comprising:
a dynamic engagement code generator adapted to translate a set of engagement rules, each rule including at least one targeting condition along with a corresponding triggered engagement actions, into dynamic engagement code containing a rule engine configured substantially in accordance with the set of engagement rules; and
a computer server from which the dynamic engagement code is transferred onto a customer related computing platform for execution.

2. The system according to claim 1, wherein the dynamic engagement code is functionally associated with a campaign or company specific configuration file.

3. The system according to claim 2, wherein the functionally associated configuration file either overrides a native behavior of said rule engine or provides an operational parameter for a triggered action of said rule engine.

4. The system according to claim 1, wherein the dynamic engagement code is lazy loading code.

5. The system according to claim 1, wherein the dynamic engagement code launches at least one locally cached process on the customer related computing platform.

6. The system according to claim 1, wherein said dynamic engagement code includes a network communication component adapted to, once executed on the customer related computing platform, communicate with one or more communication modules of said dynamic customer engagement system.

7. The system according to claim 6, further comprising an engagement code communication module adapted to facilitate communication between engagement code running on a customer related computing platform and one or more resources of said dynamic customer engagement system.

8. The system according to claim 1, further comprising one or more data collectors adapted to retrieve customer related information or enterprise state related information from one or more data systems, wherein said one or more data systems are either enterprise data systems or third party data systems.

9. The system according to claims 8, wherein said data collectors are adapted to generate and store a customer data structure reflective of the retrieved information.

10. The system according to claim 8, wherein said data collectors are adapted to provided collected information substantially directly to said dynamic engagement code running on a customer related computing platform through an engagement code communication module.

11. The system according to claim 8, wherein one or more data collectors adapted to retrieve enterprise state related information from one or more data systems are further adapted to provide the retrieved information to an automated engagement rule tuning module.

12. The system according to claim 8, wherein said one or more data collectors include an interface selected from the group of interfaces consisting of: (1) a Social Network Interface, (2) a CRM System Interface, (3) a Customer Survey/Feedback System Interface, (4) a Accounting System Interface, (5) a Fulfillment/Delivery System Interface, (6) a Inventory/Supply Management System interface, (7) a Data Mining and Business Intelligence System Interface, and (8) a Third Party Data System Interface.

13. The system according to claim 1, further comprising one or more client engagement interfaces adapted to facilitate an actual customer engagement, according to a defined customer engagement method, responsive to a triggering action from said dynamic engagement code running on a customer related computing platform.

14. The system according to claim 13, wherein a facilitated engagement is according to an engagement method selected from the group of methods consisting of: (1) presenting a customer with a reward or special offer, (2) providing a customer with a discount, coupon or rebate, (3) triggering a chat session between the customer and a representative, (4) triggering an automated response session, (5) triggering live call between the customer and a representative, and (6) launching a third party engagement method.

15. The system according to claim 13, further comprising an engagement method effectiveness assessment module adapted to assess an effectiveness level of a given engagement method, under specific targeting conditions, by monitoring customer interactions with one or more actual engagements according to the given engagement method and triggered based on the specific targeting condition.

16. The system according to claim 15, wherein said effectiveness assessment module is further adapted to provide assessment information to one or more of: (1) an automated engagement rule tuning module, and (2) a reporting system.

17. The system according to claim 15, wherein said effectiveness assessment module is further adapted to assess relative effectiveness levels of two or more engagement methods whose actual engagements are being triggered using substantially identical targeting conditions.

18. The system according to claim 17, wherein said effectiveness assessment module is adapted to convey to said automated engagement rule tuning module information indicative of the relative effectiveness of the two or more engagement methods and said automated engagement rule tuning module is adapted to adjust engagement rules accordingly.

19. The system according to claim 18, wherein engagement rules are tuned in favor of more relatively prevalent triggering of actual engagements accordingly to engagement methods assessed of as being associated with relatively higher effectiveness levels.

20. A method for providing dynamic customer engagement, said system comprising:
translating a set of engagement rules, having at least one targeting condition along with a corresponding triggered engagement actions, into dynamic engagement code containing including a rule engine configured substantially in accordance with the set of engagement rules; and
digitally conveying the dynamic engagement code onto a customer related computing platform for execution.
